(19) United States
(12) Patent Application Publication
(10) Pub. No.: US 2009/0049460 A1
(43) Pub. Date: Feb. 19, 2009

(54) Loading mechanism for loading an interchangeable disc-like storage meduim into a housing

(76) Inventors: Joachim Kernbach, Villingen (DE); Juergen Moessner, Brigachtal (DE)

Correspondence Address: Joseph J. Laks;Thomson Licensing LLC, 2 Independence Way, Patent Operations, PO Box 5312, PRINCETON, NJ, 08543, US

(21) Appl. No.: 11/919,840

(22) PCT Filed: Apr. 10, 2006
(86) PCT No.: PCT/EP2006/061487

§ 371 Date: Nov. 2, 2007

(30) Foreign Application Priority Data
May 4, 2005 (DE) 10 2005 021 338.3

(51) Int. Cl. G11B 17/04

(52) U.S. Cl. 720/619; G9B/17.013

(57) ABSTRACT

The invention relates to a loading mechanism for loading an interchangeable disc-like storage medium into a housing, in which a disk drive having a holder for the storage medium and an optical scanning device for the latter are arranged. It achieves the object of providing a loading mechanism which is space-saving and permits loading and unloading which takes care of the motor of the disk drive and of the storage medium. For this purpose, this loading mechanism is formed from a loading table for the storage medium which can be pivoted between a loading position and a deposition position on the holder, and an actuating apparatus for said loading table.

The invention relates to a loading mechanism for loading an interchangeable disc-like storage medium onto a disk drive arranged in a housing, for example a housing of the PCMCIA size, in particular for loading an approximately coin-size disk (coin disk) with a diameter of substantially 30 mm.

A loading mechanism of this type is used to move a disc-like storage medium, for example an optical storage medium, in a mechanical way into a predetermined position on a disk drive arranged in the housing. For this purpose, JP 09-306078 discloses a loading mechanism for a storage medium which is arranged in a cartridge on a tray. In order to move it onto the disk drive, the tray having the storage medium is pulled out of the predeterminedly positioned cartridge until it is above the disk drive and is then lowered. In this case, the storage medium is deposited in a predetermined position on a support on the disk drive. The loading mechanism takes up a great deal of space. In the case of a coin-size disk, the problem is additionally posed that relatively small disk motors also have relatively small shaft bearings, which means that these are less robust than the disk drive motors used in disk drives for larger storage media, for example having a diameter of 120 mm, and are loaded considerably by the abrupt separation of the storage medium from the disk drive.

The object of the invention is to provide a loading mechanism for loading an interchangeable disc-like storage medium into a housing according to the precharacterizing clause of claim 1 which saves space and permits loading and unloading which takes care of the motor of the disk drive and of the storage medium.

This object is achieved by the features of claim 1. Advantageous refinements are listed in the subclaims.

The invention consists in a loading mechanism for a housing in which a disk drive having a holder for the storage medium and a scanning device for the latter are arranged, which has a loading table which can be pivoted between a loading position at a distance from the holder and a deposition position on the holder and is provided with an actuating apparatus. In this case, the loading table is preferably attached on one side and is loaded by a spring force in the direction of the loading position. The actuating apparatus acts on the loading table and presses the latter into the deposition position and holds this in this position. By means of an opposing movement of the actuating apparatus, the spring-force-loaded loading table is freed from its pressed-down deposition position and pivoted into the loading position by the loading spring means. The loading table is cut out, at least in the scanning region predetermined by the scanning device.

This loading mechanism is advantageous in particular in the case of small disk drives in which, during fitting and removal, only low, defined forces must act, since the loading table having the storage medium is lowered counter to the spring force in a highly damped manner by means of a pivoting movement about an axis of rotation outside the holder and is held on the latter. As it is lowered, the storage medium is positioned accurately by a centring unit arranged on the holder, preferably designed as a lengthened axle of the disk drive motor formed as a centring mandrel. The loading mechanism is simple and not very complicated and needs only little overall space. The pivoting angle of the loading table is substantially 3° to 10°.

The holding of the storage medium on the holder can be carried out mechanically by latching means or preferably magnetically. Magnetic holding of the storage medium is carried out either directly by a magnetically effective material that is integrated into the storage medium and which is attracted by the permanent magnet rotor of the disk drive motor, or as a clamping action between two magnetically attracting parts, one part being firmly connected to the rotor of the disk drive motor. In the preferred embodiment, magnetic holding is carried out by the storage medium being attracted by the magnetic field of the rotor permanent magnet of the disk drive motor. During loading and unloading, the storage medium is lowered onto the holder and lifted off the holder by the loading table. Since the loading table is pivoted about an axis at a distance from the holder, the storage medium is not lowered onto the holder or pulled off the holder in a plane-parallel manner but is lowered gradually into the magnetic field and released from the magnetic field by means of slight tilting, coupled with a continuous increase and reduction, respectively, in the attraction forces. As a result, the forces acting in the axial direction are minimized and the disk drive motor is loaded to only a minimal extent.

The actuating apparatus is formed by a cam arranged on the loading table, preferably on one of the side edges adjacent to the attachment side, designed by way of example as a ramp, and a sliding element that can be brought into engagement therewith and is arranged on the housing. This sliding element is pushed against the cam which, in the process, with the loading table, is pressed towards the holder until in the deposition position, counter to the force of the spring means acting on said loading table. The sliding element is preferably formed by a sliding cover closing the housing. In this case, no separate fixing of the loading table has to be provided, since it is held in the deposition position against a spring element via the cam having the sliding cover.

Further advantages, in particular for mobile applications, are, firstly, the omission of a motor drive for the loading mechanism, since mechanical actuation by hand is provided. In the case of mobile applications operated with a battery or rechargeable battery, the energy requirements must be reduced as far as possible. Secondly, the loading operation of a storage medium is implemented in the smallest possible space since, as compared with known flap cover solutions, the sliding cover is moved parallel to the housing and the space requirement during the loading operation arising from projecting components around the housing is minimized.

The loading table can be attached in the manner of a hinge to a bearing shaft, on which at least one spiral torsion spring supported at one end on the housing and at the other end on the loading table is arranged, acting on the latter in the direction of the loading position. On the side facing away from the bearing shaft, depending on its size, the loading table can be provided with a cut-out in the region of the holder of the disk drive, in order that the storage medium can be deposited on the holder.

In order that a storage medium can be loaded even in a virtually vertical position of the loading table located in its loading position, in a further embodiment, said loading table is provided on its attached side edge and the two side edges adjacent to the latter with hook-like holding elements for the storage medium which, when one such is inserted, engage over its edge. A storage medium can thus be pushed under these holding elements and held by them.

The invention will be explained below by using two exemplary embodiments. In this case, reference is made to an optical storage medium. Of course, the invention can also be used for other storage media, for example magnetic storage media. In the associated drawings:

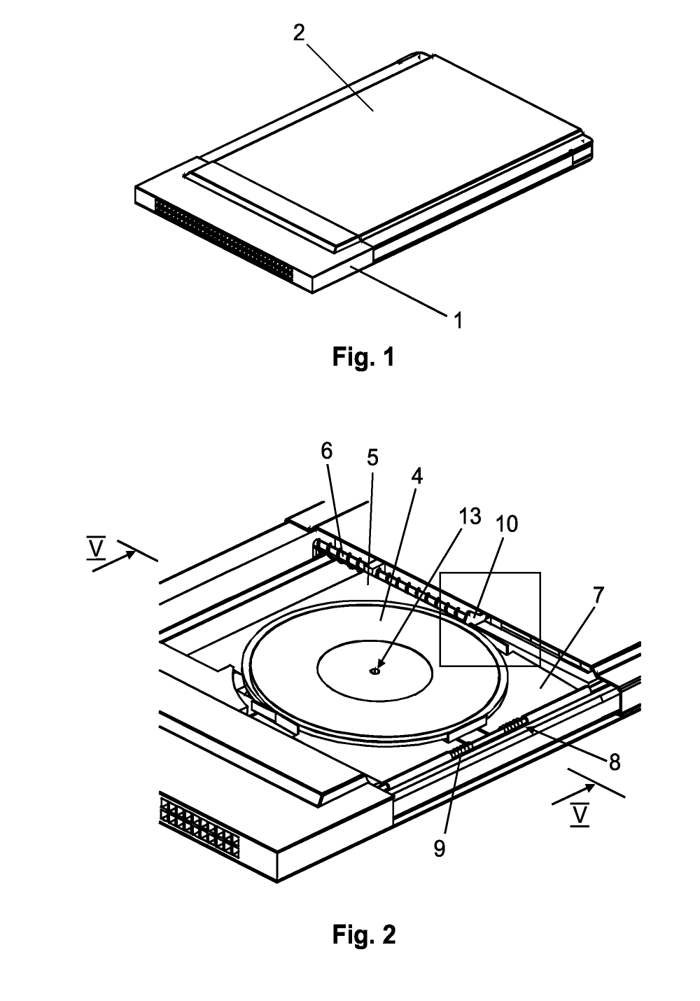

FIG. 1 shows a PCMCIA housing, closed,

FIG. 2 shows this in the open state with a 30 mm storage medium (coin-size disk) in the loading position,

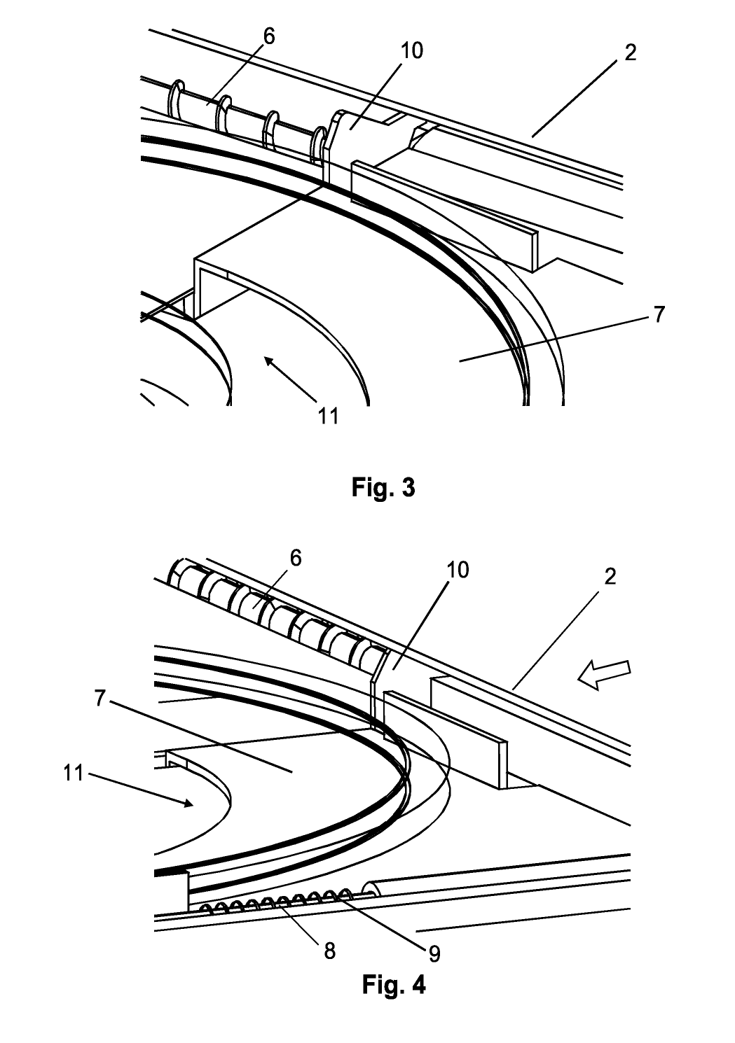

FIG. 3 shows a detail of the loading table with a ramp arranged on the latter in the loading position, enlarged,

FIG. 4 shows this detail with the sliding cover partly pushed closed and the loading table lowered, enlarged,

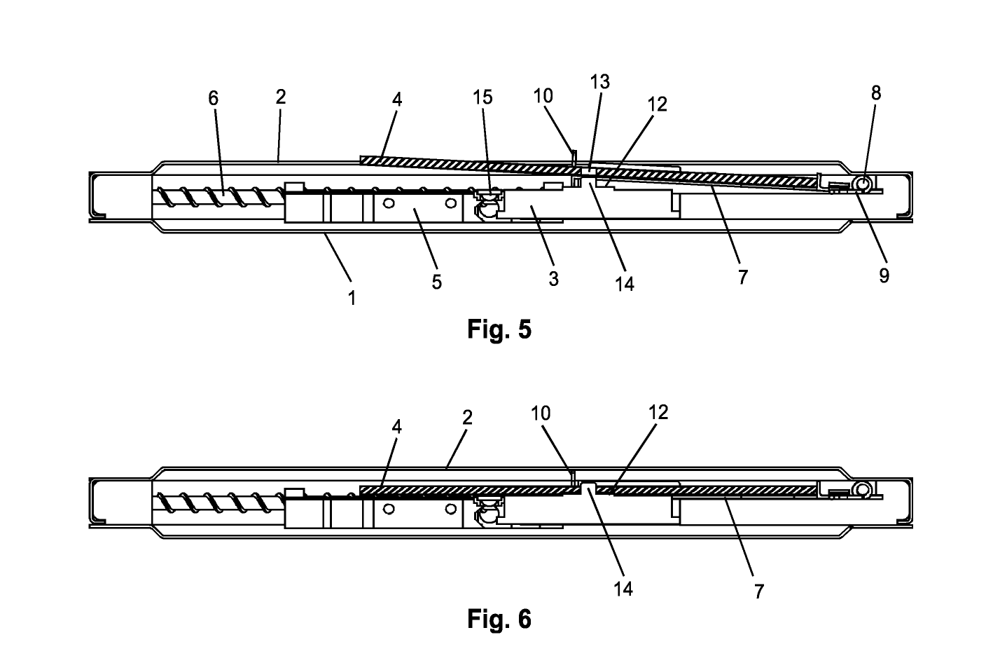

FIG. 5 shows a section V-V through the PCMCIA housing with loading table and storage medium in the loading position,

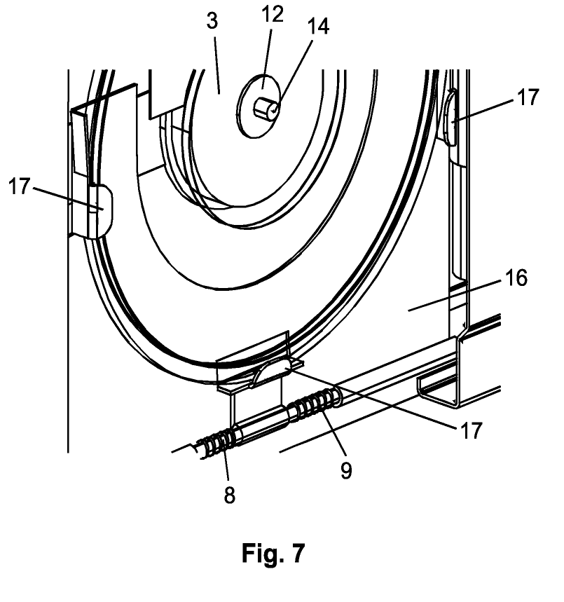

FIG. 6 shows this section with the loading table and storage medium in the deposition position, and

FIG. 7 shows a further embodiment of the loading mechanism.

FIGS. 1 and 2 show a PCMCIA housing in the closed and in the opened state. A PCMCIA housing is to be understood to mean a housing which can be used on a PCMCIA interface, as is common in Notebooks, for example. In addition, other housing sizes are of course possible, for example a housing in the Microdrive/Compact Flash or other format. The PCMCIA housing 1 shown in FIGS. 1 and 2 has a sliding cover 2 and, in its interior, a disk drive with a motor (3, FIGS. 5, 6) for the storage medium 4 and also an optical scanning device (pickup) 5, which is operatively connected to a drive worm 6 and which scans the storage medium 4 optically in the radial direction parallel to the drive worm 6. Furthermore, the loading mechanism can also be used in conjunction with other design variants of a read/write head system, for example a read/write head mounted on a swinging arm known from hard-drive technology. The storage medium 4 rests on a loading table 7, which is mounted and attached on one side on a bearing shaft 8, can be pivoted about the latter and is acted on with a spring force by means of helical torsion springs 9 or other spring elements in the direction of the loading position shown, the springs 9 being supported at one end on the housing 1 and at the other end on the loading table 7. From this loading position, the loading table 7 can be pressed into the housing by 3°-10° into a deposition position.

To this end, the loading mechanism has a cam 10 arranged firmly on the edge of the loading table 7 and having a sliding surface which is formed on the side facing away from the loading table 7, which rises in the direction of the loading table 7 and with which the sliding cover 2 can be brought into engagement during its closing movement parallel to the bearing shaft 8, so that the loading table 7 is pressed into its deposition position, in which the storage medium 4 located on said loading table 7 is deposited on the motor (3, FIGS. 5, 6) of the disk drive. The arrangement of the cam 10 and its two positions are illustrated in FIGS. 3 and 4.

FIG. 3 shows the loading table 7 with the cam 10 in the loading position. It is also possible to see that the loading table 7 extends only as far as the cam 10 and has a circular cut-out 11. In the region of this cut-out, the motor (3, FIGS. 5, 6) of the disk drive is located with a holding surface (12, FIGS. 5, 6) for the storage medium. The loading table 7 is pressed slightly below the level of the holding surface (12, FIGS. 5, 6) as it is pressed into the deposition position (FIG. 4), so that the storage medium 4 as it were gets caught on the holding surface 12 and is deposited on the latter and is held on the latter by the magnetic field of the permanent magnet of the disk drive motor 3 and cannot rub on the loading table during operation.

In FIGS. 5 and 6, the loading position and the deposition position are illustrated in the section V-V (FIG. 2). FIG. 5 shows the loading table 7 placed slightly obliquely with the cam 10 in the loading position with the storage medium 4 located on the loading table and their assignment to the motor 3, and also the assignment of the scanning device 5 to the storage medium 4. It can be seen that the storage medium 4 is arranged with a centring opening 13 above a mandrel 14 projecting on the holding surface 12. The scanning device 5 is located on the side of the disk drive motor 3 facing away from the loading table 7 and is provided with a focusing lens 15 for the optical scanning of the storage medium 4. FIG. 6 shows the storage medium 4 deposited on the holding surface 12, the centring mandrel 14 projecting through the centring opening 13 and positioning the storage medium 4 in a defined manner. It is also possible to see the cam 10 pressed down by the sliding cover 2.

If the storage medium 4 is to be exchanged, the PCMCIA housing 1 is opened by pushing the sliding cover 2 back. At the end of the opening movement (FIG. 2), said sliding cover 2 comes out of engagement with the cam 10, the engagement being released steplessly because of the sliding surface, so that the loading table 7 is pressed out of the deposition position into the loading position as a result of the loading by the helical torsion springs 9. In the process, the storage medium 4 is gripped by the loading table 7 and gradually released gently from the holding surface 12. In the loading position, the storage medium 4 is lifted off the loading table 7.

FIG. 7 shows a second embodiment of the loading mechanism. This differs from that described previously in that the loading table 16 is provided on the side of the bearing shaft and on the two adjacent side edges with hook-like holding elements 17 for a storage medium 4. This embodiment thus permits a storage medium 4 to be pushed in between the holding elements 17 and the deposition surface of the loading table 16, so that loading is made possible even with a vertical housing position.

A further design variant provides a loading table which, in its geometry, is designed to hold a storage medium 4 mounted in a protective housing (cartridge). In this case, the configuration of the holding elements 17 is adapted to the geometry of the protective housing in a manner similar to FIG. 7. If the protective housing is pushed into the holding elements 17 and fixed only at the outer edge, the loading table can be designed without any supporting surface, that is to say in the form of a fork, which means that the overall space can be reduced accordingly.

### LIST OF REFERENCE SYMBOLS USED

1 Housing
2 Sliding cover
3 Disk drive motor
4 Storage medium
5 Scanning device
6 Drive worm
7 Loading table
8 Bearing shaft
9 Helical torsion spring
10 Cam
11 Cut-out
12 Holding surface
13 Centring opening
14 Centring mandrel
15 Focusing lens
16 Loading table
17 Holding element

1. Loading mechanism for loading an interchangeable disc-like storage medium into a housing, in which a disk drive having a holder for the storage medium and a scanning device for the latter are arranged, wherein the loading mechanism is formed from a loading table for the storage medium, which can be pivoted between a loading position and a deposition position on the holder, and an actuating apparatus for said loading table.

2. Loading mechanism according to claim 1, the loading table being attached on one side and loaded by a spring force in the direction of the loading position and, by means of the actuating apparatus, being pivoted from the loading position into the deposition position and, during an opposing movement of the actuating apparatus, being pivoted from the deposition position into the loading position by the spring force.

3. Loading mechanism according to claim 1, the loading table having a cut-out in the region of the holder and being cut out at least in the scanning region of the scanning device on the storage medium.

4. Loading mechanism according to claim 1, the actuating apparatus being formed by a cam arranged on the loading table and a sliding element which can be brought into engagement with the cam and is arranged on the housing, the cam being arranged on a side edge of the loading table adjacent to the attachment side of the latter.

5. Loading mechanism according to claim 4, the sliding element being a sliding cover arranged on the housing.

6. Loading mechanism according to claim 1, the loading table being attached to a bearing shaft, on which at least one spring element supported at one end on the housing and at the other end on the loading table is arranged, which loads the latter in the direction of the loading position.

7. Loading mechanism according to claim 1, the holder being located in the magnetic field of the permanent magnet of the rotor of the disk drive motor and being provided with a centring mandrel for the storage medium.

8. Loading mechanism according to claim 1, wherein the pivoting angle of the loading table is substantially 3° to 10°.

9. Loading mechanism according to claim 1, wherein this is used in a standardized housing.

10. Device for reading and/or writing storage media, wherein it uses a loading mechanism according to claim 1.
